(19) United States
(12) Patent Application Publication
(10) Pub. No.: US 2022/0156689 A1
(43) Pub. Date: May 19, 2022

(54) DELIVERY SYSTEM

(71) Applicant: AISIN CORPORATION, Kariya (JP)

(72) Inventors: Hideyuki IWATA, Kariya-shi (JP); Wakana FUCHIGAMI, Kariya-shi (JP); Seiji MIYAMOTO, Kariya-shi (JP)

(73) Assignee: AISIN CORPORATION, Kariya (JP)

(21) Appl. No.: 17/452,430

(22) Filed: Oct. 27, 2021

(30) Foreign Application Priority Data
Nov. 19, 2020 (JP) 2020-192200

(51) Int. Cl. G06Q 10/08; G06Q 10/06; G06Q 30/06; G06Q 50/30

(52) U.S. Cl. CPC G06Q 10/0833; G06Q 50/30; G06Q 30/0635; G06Q 10/06316

(57) ABSTRACT

A delivery system includes: a management server configured to acquire and accumulate order information of an order made from a user terminal of one user within a set time, the order information including store information, product information, delivery destination information, and delivery time information, transmit the order information to a delivery person terminal of one delivery person, transmit the product information and the delivery time information to a store terminal of a store, and allow the user to order the products in plural stores in the order each time, generate the order information for the order in each time, and when it is determined that the orders of the one user are made across plural stores, generate pickup sequence information determining a sequence in which the one delivery person is to receive the products in the stores, and further transmit the pickup sequence information to the delivery person terminal.

### CROSS REFERENCE TO RELATED APPLICATIONS

This application is based on and claims priority under 35 U.S.C. § 119 to Japanese Patent Application 2020-192200, filed on Nov. 19, 2020, the entire content of which is incorporated herein by reference.

### TECHNICAL FIELD

This disclosure relates to a delivery system in which a user can receive, by delivery, a product ordered by the user via a network.

### BACKGROUND DISCUSSION

As a delivery system configured as described above, there are techniques described in JP-T-2020-504853 (Reference 1) and JP-A-2019-113973 (Reference 2).

In the technique of Reference 1, processing proceeds as follows. That is, a home delivery service provider management system first selects a supply source position and a home delivery service provider to create order entry information. The home delivery service provider management system sends order information from the order entry information to a home delivery service provider device of the selected home delivery provider and a supply source device. The order information includes an order ID, a supply source ID, and a home delivery service provider ID, and the supply source device transmits a beacon including the supply source ID and the order ID. Then, the home delivery service provider device detects a short distance beacon signal from the supply source device, detects whether the detected supply source ID and order ID match the supply source ID and order ID received from the order information, and in response to success, the home delivery service provider device verifies proximity for the supply source device.

In the technique of Reference 1, when a requesting user (user) accesses the home delivery service provider management system of a home delivery service provider user (delivery person) via a network, the home delivery service provider management system displays, in a form of a GUI, a plurality of items that can be ordered on a terminal of the requesting user, and creates an order entry when the requesting user selects an item. Information such as items and quantities included in the order entry is received by a supply source user (manager of a store). A home delivery service provider user is assigned, and information associated with the order is received by a home delivery service provider device of the home delivery service provider user.

In the technique of Reference 1, the supply source user (the manager of the store) prepares a product (for example, cooks a pizza when the supply source is a pizza store), the home delivery service provider user, that is, the delivery person, receives the product, and delivers the product to a delivery position designated by the requesting user (user).

In the technique of Reference 2, a customer (user) accesses a local server from an information terminal device, orders a product desired to be ordered in a distributor (store) in a form of writing the product on a personal order sheet, and whereby information on the personal order sheet is stored in the local server. Thereafter, when a set time is reached, the local server creates an order aggregation sheet based on the personal order sheet and transmits the order aggregation sheet to the distributor via the network.

In the technique of Reference 2, when a plurality of customers (users) order products to different distributors, aggregated order sheets (order aggregation sheets) are transmitted to the respective distributors (stores). Therefore, for example, as compared with a case where the distributor individually receives the orders from a plurality of users by telephone or facsimile in order to receive orders, complexity is eliminated, and it is possible to delivery products by the distributor based on the order aggregation sheet.

For example, when considering a system that delivers box lunches ordered by the user via the network, as described in Reference 1, it is possible to imagine a server that connects the user, the store, and the home delivery service provider to the network in a form of mediating pieces of information.

However, in the technique described in Reference 1, since the system is constructed such that a product received in a single store is delivered to the user, for example, when one user purchases products from a plurality of stores and desires delivery of each product, different pieces of order information is created and home delivery service providers whose number corresponding to the number of the pieces of order information are used.

In the technique described in Reference 2, although the orders from a plurality of users for the plurality of stores (sellers) can be aggregated, it is necessary for each store to separately deliver the products after the order aggregation sheet is transmitted to each store.

Here, considering that one user makes orders in a plurality of stores, in the technique of Reference 1, even if there is one delivery destination, a plurality of delivery persons are used. Therefore, for example, when the delivery person uses a vehicle, a plurality of vehicles travel, and thus it cannot be said that delivery efficiency is high. Considering that the technique described in Reference 2 is used for such inconvenience, the plurality of vehicles or motorcycles travel to one delivery destination, and it is not possible to increase the delivery efficiency, and thus there is a room for improvement.

Further, considering a situation in which a plurality of users order products in a specific store, in the technique of Reference 1, since the plurality of orders are handled individually, there are a plurality of delivery destinations of the products, and when the delivery person uses, for example, a vehicle, a plurality of vehicles travel, and thus it cannot be said that the delivery efficiency is high. Considering that the technique described in Reference 2 is used for such inconvenience, it can be imagined that the delivery efficiency of the vehicle is increased since the order aggregation sheet is sent to each of the plurality of stores (distributors) in the technique. However, in the technique described in Reference 2, since the store carries out the delivery, the vehicle in the store which does not receive the order is not operated, which leads to an inconvenience that the operation efficiency of the vehicle is lowered depending on the store, and thus there is a room for improvement.

A need thus exists for a system which is not susceptible to the drawback mentioned above.

### SUMMARY

A feature of a delivery system according to an aspect of this disclosure resides in that the delivery system includes: a management server configured to acquire and accumulate order information of an order made from a user terminal of one user within a set time via a network, the order information including at least store information on a store in which the user makes the order, product information by which an ordered product is able to be specified, delivery destination information as a delivery destination of the ordered product, and delivery time information as a time at which the product is delivered, transmit the order information acquired by the management server to a delivery person terminal of one delivery person via the network, transmit at least the product information and the delivery time information in the order information acquired by the management server to a store terminal of the store based on the store information in the order information via the network, and allow the user to order the products in a plurality of the stores in the order each time, generate the order information for the order in each time, and when it is determined that the orders of the one user are made across a plurality of the stores based on the order information accumulated within the set time, generate pickup sequence information determining a sequence in which the one delivery person is to receive the products in the plurality of the stores, and further transmit the pickup sequence information to the delivery person terminal.

A feature of a management server according to an aspect of this disclosure resides in that the delivery system includes: a management server configured to acquire and accumulate order information of an order made from a user terminal of each of one or a plurality of users within a set time via a network, the order information including at least store information on a store in which the user makes the order, product information by which an ordered product is able to be specified, delivery destination information as a delivery destination of the ordered product, and delivery time information as a time at which the product is delivered, transmit the order information acquired by the management server to a delivery person terminal of one delivery person via the network, transmit at least the product information and the delivery time information in the order information acquired by the management server to a store terminal of the store based on the store information in the order information via the network, and allow each of the users to order products in a plurality of the stores in the order each time, generate the order information for the order in each time, and when it is determined, based on the order information accumulated within the set time, that a plurality of the users make orders in the same store, sets delivery sequence information determining a sequence in which the one delivery person is to deliver the products to the plurality of the users who make orders in the same store, and further transmit the delivery sequence information to the delivery person terminal.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram showing an outline of a delivery system;

FIG. 2 is a chart showing an outline of a flow of information and pickup and delivery in a multi-store designation mode;

FIG. 3 is a flowchart showing processing of a management server in the multi-store designation mode;

FIG. 4 is a flowchart of order reception processing in the multi-store designation mode;

FIG. 5 is a flowchart of order processing in the multi-store designation mode;

FIG. 6 is a flowchart of pickup and delivery request processing in the multi-store designation mode;

FIG. 7 is a diagram sequentially showing screen displays when an order is placed on a user terminal;

FIG. 8 is a diagram showing screen displays when delivery destination information is input by the user terminal;

FIG. 9 is a chart showing an outline of a flow of information and pickup and delivery in a multi-user mode;

FIG. 10 is a flowchart showing processing of the management server in the multi-user mode;

FIG. 11 is a flowchart of order reception processing in the multi-user mode;

FIG. 12 is a flowchart of order processing in the multi-user mode;

FIG. 13 is a flowchart of pickup and delivery request processing in the multi-user mode;

and

FIG. 14 is a flowchart showing processing of the management server in a combined pickup and delivery mode.

### DETAILED DESCRIPTION

Hereinafter, embodiments disclosed here will be described with reference to the drawings.

### (Delivery System)

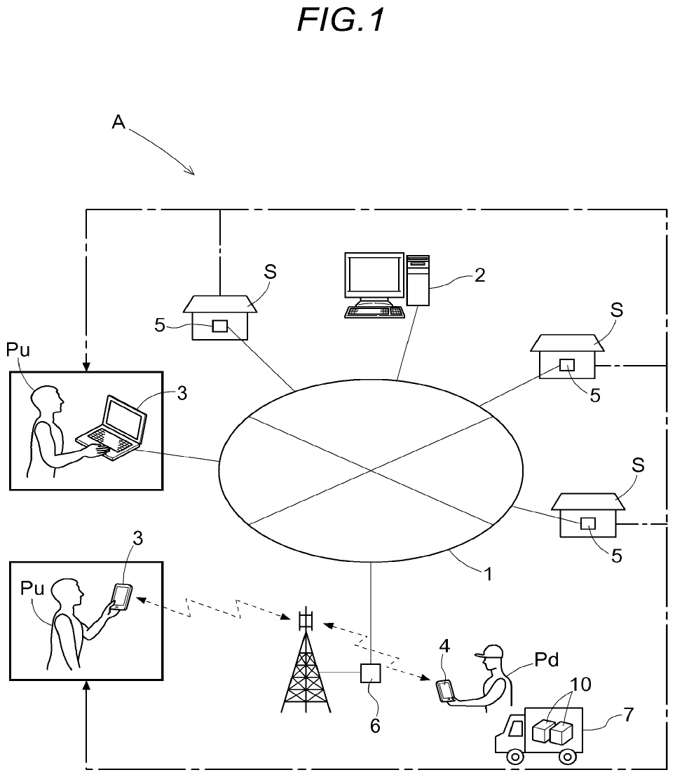

As shown in FIG. 1, a delivery system A includes a management server 2 connected to the Internet 1 (a specific example of a network), user terminals 3 of users Pu which can be connected to the Internet 1, a delivery person terminal 4 of a delivery person Pd which can be connected to the Internet 1, and store terminals 5 of stores S which can be connected to the Internet 1.

In the delivery system A, any of the user terminal 3, the delivery person terminal 4, and the store terminal 5 may be wirelessly connected to the Internet 1 with respect to a base station 6.

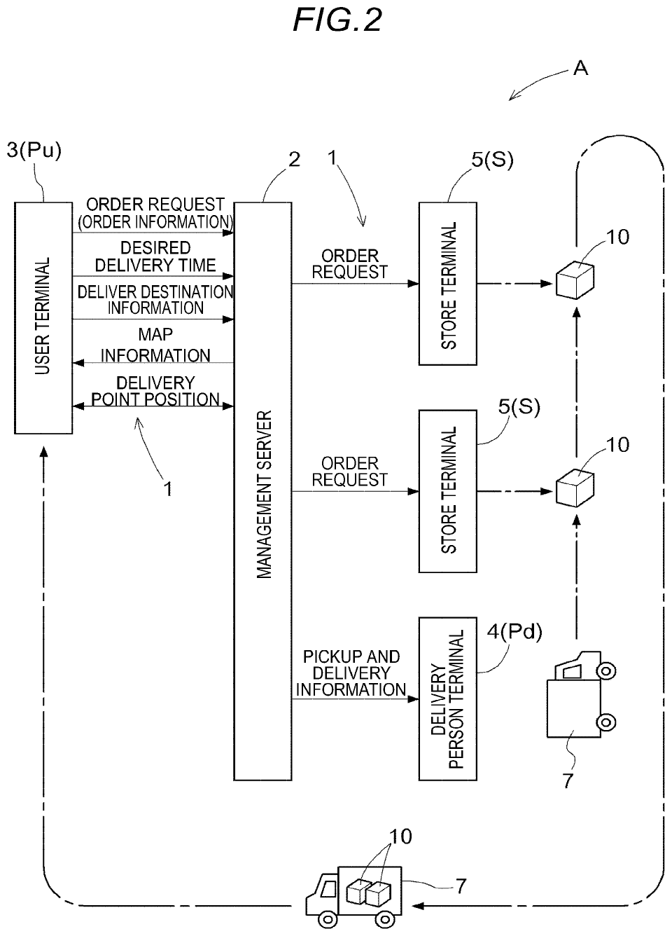

In the delivery system A, a plurality of users Pu connect (log in) to the management server 2 via the Internet 1 by operating the user terminals 3, designates any one of a plurality of stores S, selects products 10 (see FIGS. 1 and 2), and orders the products 10, thereby transmitting order information to the delivery person terminal 4, and the delivery person Pd receives the products 10 in the store S and delivers the products 10 to the users. The management server 2 generates one piece of order information every time one user Pu makes an order. Specific information included in the order information will be described later.

The delivery system A can receive orders from the plurality of users Pu within a set time, and further, one user Pu can designate a plurality of stores S in one order and select and order the products 10 in the designated plurality of stores S. When there is one order in which one user Pu designates a plurality of stores S, the management server 2 performs a delivery in a “multi-store designation mode” in which one delivery person Pd uses one vehicle 7 to receive the product 10 in each store S in the plurality of stores S and to deliver the products 10 to the user Pu. The products 10 may be the same product or may be different products.

In the delivery system, when a plurality of users Pu designate the same store S (one store S) and order the products 10 in the designated store S, a deliver is performed in a “multi-user mode” in which one delivery person Pd uses one vehicle 7 to receive a plurality of products 10 in the store S and to deliver the plurality of products 10 sequentially to the plurality of users Pu.

That is, the management server 2 of the delivery system A is configured to analyze the order information of one or a plurality of users Pu within a set time, select a delivery in the multi-store designation mode and a delivery in the multi-user mode, and perform pickup and delivery in a “combined pickup and delivery mode” to be described later in order to efficiently pickup and deliver the product 10.

The delivery system A has a function by which a manager (not shown) of the management server 2 can browse a content of the order information, a progress status of the pickup and delivery performed by the delivery person Pd, and the like, and is configured to limit the number of logins of the user Pu and limit the number of orders of products by setting in advance an upper limit of the number of pieces of the order information, an upper limit of a progress of delivery performed by the delivery person Pd, and the like.

Although a process for paying for the ordered product 10 is not shown in the following description, for example, when the user logs in to the management server 2, a plurality of types of fee payment methods are displayed on a screen of the user terminal 3, and the user can select the payment method from the display. As the fee payment method, it is also conceivable to download an application for using the delivery system A, and register information of a credit card necessary for payment in the application, information of an account that enables payment, and the like.

### (Multi-Store Designation Mode)

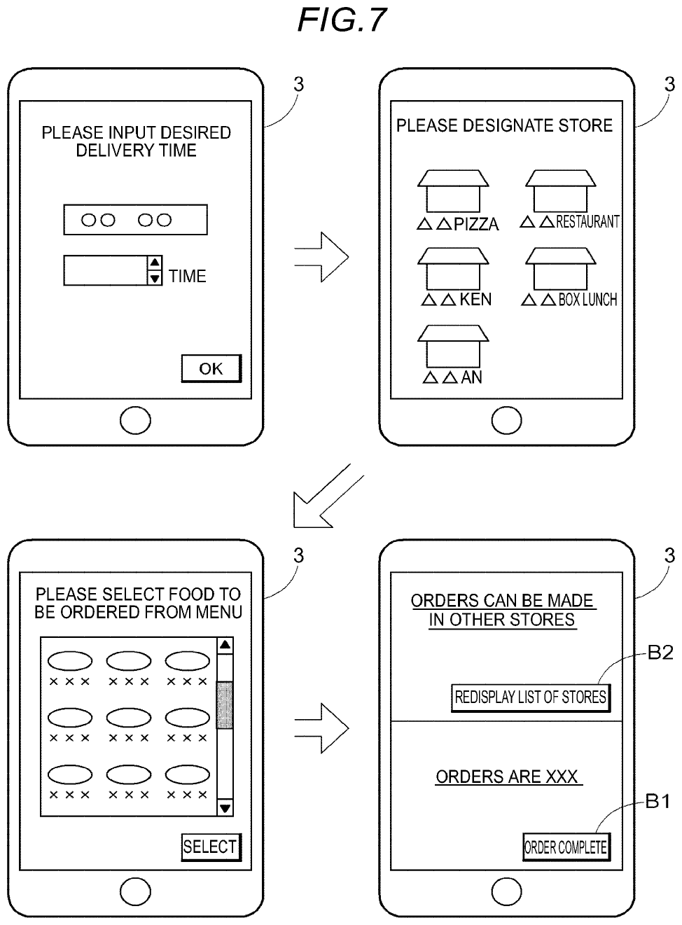

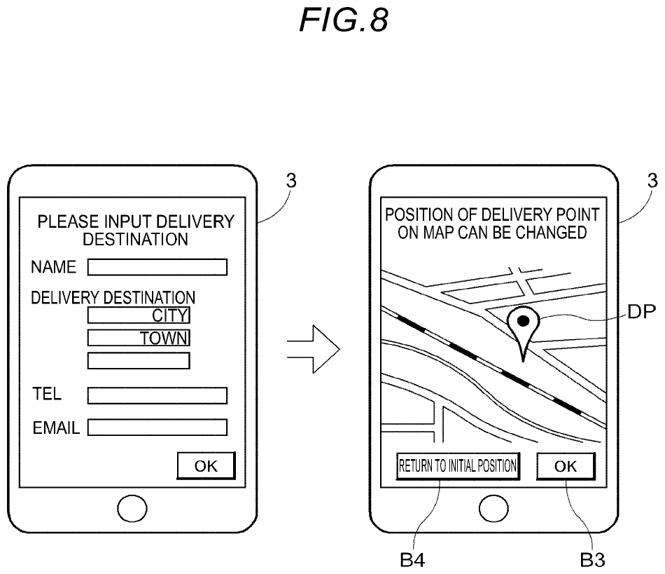

An example in which, as the product 10 purchased in the multi-store designation mode, food 10 (an example of the product) cooked like a pizza, a box lunch, or a regular meal is ordered at one time in a plurality of stores S will be described. In the following description, it is assumed that information is transmitted as shown in a chart in FIG. 2 and screens shown in FIGS. 7 and 8 are displayed on the user terminal 3.

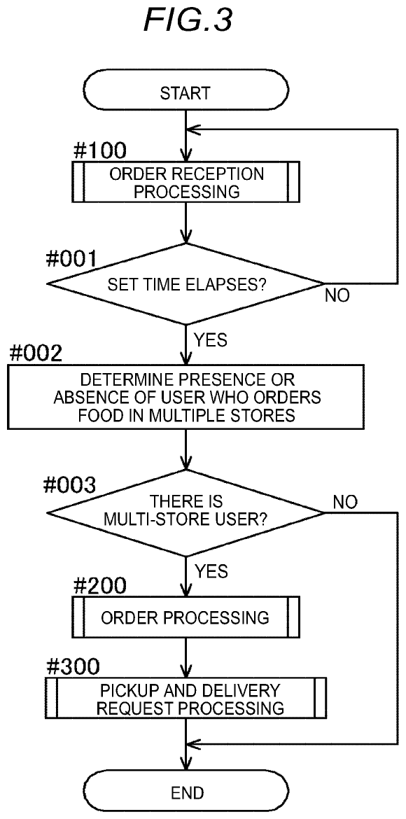

In the multi-store designation mode, as shown in a flowchart in FIG. 3, the management server 2 performs order reception processing (step #100, step #001) for a plurality of orders within a set time. The order reception processing (step #100) is processing of receiving an order of the food 10 (product) made by the user Pu who logs in to the management server 2. In the order reception processing, presence or absence of the user Pu (hereinafter, also referred to as a multi-store user) who orders the food 10 in a plurality of stores S is determined. When the multi-store user exists (Yes in steps #002 and #003), the order processing (step #200) corresponding to the multi-store designation mode and the pickup and delivery request processing (step #300) is performed.

In the following description, the description will be made on an assumption that the multi-store user exists in step #003. When there is no user Pu who orders the food 10 in a plurality of stores S (No in step #003), the processing moves to peer-to-peer mode processing (not shown) in which the food 10 is delivered from one store S to one user Pu.

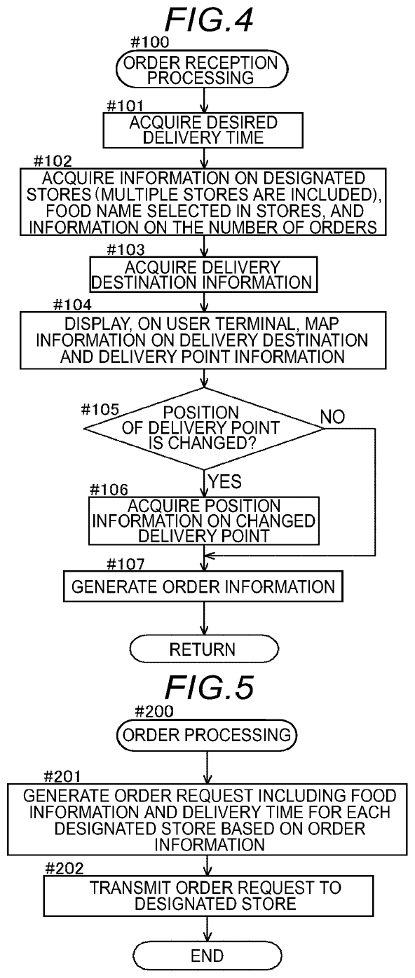

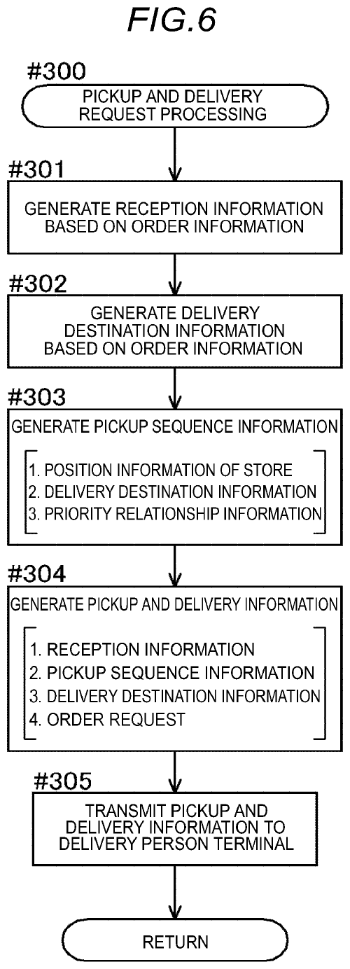

As shown in a flowchart in FIG. 4, in the order reception processing (step #100), when the user Pu logs in to the management server 2 in the user terminal 3, the management server 2 displays, on the user terminal 3, a delivery time acquisition screen shown on a left side of an upper stage in FIG. 7 and a desired delivery time input by the user Pu in the user terminal 3 is acquired by the management server 2 (step #101).

The management server 2 does not set the desired delivery time input on the delivery time acquisition screen as it is, and the delivery time is set at a time interval that is a preset setting interval such as an interval of one hour, for example, even if the desired delivery time is 5:30 p.m., the delivery time is set to 6 p.m., or the like. Although not shown in the drawings, the delivery time set in this manner is displayed on the delivery time acquisition screen, and confirmation of the user Pu is requested.

Next, a store designation screen shown on a right side at the upper stage in FIG. 7 is displayed on the user terminal 3, and the store S can be designated by an operation such as touching any of icons of the stores S displayed in this manner with a finger. After the store S is designated in this manner, a food list screen shown on the left side of a lower stage in FIG. 7 is displayed. The food 10 can be selected by an operation such as touching an icon of the food 10 displayed in this manner with a finger. Although not shown in the drawings, the number of orders is input.

Next, a confirmation screen shown on the right side of the lower stage in FIG. 7 is displayed, and the order is confirmed by operating an order completion button B1 on the screen. However, a message indicating that the order is possible in another store is displayed on the confirmation screen, and the store designation screen shown on the right side of the upper stage in FIG. 7 is displayed again by operating a redisplay button B2 on the screen before the user Pu operates the order completion button B1 (before the order is confirmed). Accordingly, in addition to the previously selected food 10, the food 10 can be ordered in another store S. As a result, processing of designating a plurality of stores S and purchasing the food 10 in the multi-store designation mode is performed.

By the operation, information on a store name of the store S designated by the user Pu (multi-store user), a food name of the food 10 (product) selected and ordered in the store S, and the number of orders of the food 10 is acquired by the management server 2 (step #102). In the flowchart, an example of processing in the multi-store designation mode in which a plurality of stores S are designated will be described. Therefore, in step #102, processing in a situation in which a plurality of stores S are selected will be described below.

Next, the management server 2 displays, on the user terminal 3, a delivery destination screen shown on a left side in FIG. 8, acquires delivery destination information such as a name, an address, and a telephone number input by the user Pu, then, displays map information including a region corresponding to the acquired delivery destination information as shown on a right side in FIG. 8, and displays a delivery point DP corresponding to the delivery destination information in a manner of overlapping the map information (steps #103 and #104).

The delivery point DP displayed on the map is automatically displayed according to the address, an address display, and the like input on the delivery destination input screen, whereas a display position can be corrected, and a message indicating that the position of the delivery point DP can be changed is displayed on the screen. Accordingly, the user Pu can select the delivery point DP by touching the delivery point DP with a fingertip and move the delivery point DP by a drag operation or the like. Then, the position of the moved delivery point DP is acquired by the management server 2 (steps #105 and #106).

When there is no change in the position of the delivery point DP displayed on an initial screen of the delivery destination input screen or when the change is confirmed, the delivery point DP is confirmed by operating a confirmation button B3 on the screen. On the other hand, when it is desired to return the display position to an initial position when the position of the delivery point DP is changed, the position of the delivery point DP can also be returned to the initial position by operating a button B4 for return the position to the initial position.

After the input of the information necessary for the order reception processing is completed as described above, the management server 2 generates order information (step #107), and the generated order information is acquired by the management server 2 and accumulated (stored) in a storage.

The order information includes store information (for example, the address) including a plurality of designated store names and store position information, product information including a selected food name and the number of orders of the food 10, the delivery destination information including the name and the address of a person (basically, the user Pu) at the delivery destination and the delivery point DP displayed on the map, and delivery time information including the desired delivery time. The store position information included in the store information may be extracted from a list of a plurality of pieces of store information stored in advance in the management server 2.

In the order processing (step #200), as shown in a flowchart in FIG. 5, the product information (the food name of the food 10 selected in the designated store S and the number of orders of the food 10) included in the order information is extracted in the management server 2, order request including the product information and the delivery time information is generated, and the order request is transmitted (sent) to the designated plurality of stores S via the Internet 1 (steps #201 and #202).

By transmitting the order request to each store S in this manner, cooking of the food 10 can be started in each store S based on the order request, and a time at which the cooking is ended can also be set based on the delivery time information. Although not shown in the drawings, in the store S receiving the order request, processing of transmitting confirmation information to the management server 2 is performed.

In the pickup and delivery request processing (step #300) to be performed next, the order information is transmitted from the management server 2 to the delivery person terminal 4, whereas the order information is transmitted as information in which information necessary for pickup and information necessary for delivery can be individually displayed in the delivery person terminal 4.

That is, the store information (the store name and the store position information) of the store S from which the food 10 ordered by the user Pu (multi-store user) is received and the product information is extracted from the order information accumulated in the management server 2, and reception information for receiving the food 10 is generated based on the store information and the product information. The delivery destination information to which the food 10 ordered by the user Pu (multi-store user) is delivered is generated based on the order information accumulated in the management server 2 (steps #301 and #302).

Next, the management server 2 generates pickup sequence information based on which the delivery person Pd receives the food 10 from each store S (step #303). Specifically, the pickup sequence information is generated based on the store name and the store position information of each store S included in the store information, the previously generated delivery destination information, and preset priority relationship information. The priority relationship information may include information on a time required to cook the food 10, a property of the food 10, and a road on which the vehicle travels. As an example of the priority relationship information based on the property of the food 10, when the ordered food 10 is food 10 provided in a warmed state, a pickup sequence of the food is set to the last, and when the ordered food 10 is food provided at room temperature, the pickup sequence of the food is set to the first.

Further, the management server 2 generates pickup and delivery information (step #304). The pickup and delivery information includes the reception information, the pickup sequence information, and delivery information. The delivery information will be described later.

The reception information includes the store information (the store name and the store position information) for receiving the food 10 and the product information (the food name and the number of orders), and the store position information includes the map information indicating the position of the store S. The pickup sequence information is information on the sequence with which the delivery person goes round the plurality of stores S.

The delivery information includes the delivery destination information designated by the user Pu (multi-store user) who orders the food 10 and the order request (the food name, the number of orders, and the delivery time information). The delivery destination information includes the map information on the delivery destination and the delivery point DP. Further, the order request is used for confirmation when the food 10 is delivered to the user Pu.

The pickup and delivery information is configured such that the pickup sequence information and the delivery information (the delivery destination information and the order request) is individually displayed on the screen of the delivery person terminal 4. That is, after the pickup is performed based on the pickup sequence information, the delivery information is displayed on the screen by an operation such as tapping the screen of the delivery person terminal 4.

The pickup and delivery information generated in this manner is transmitted (sent) to the delivery person terminal 4 of the delivery person Pd (step #305). The delivery person Pd who receives the pickup and delivery information can confirm, based on the pickup sequence information displayed on the delivery person terminal 4, the position of the store S and the food 10 to be received, and can drive the vehicle 7 to travel according to the pickup sequence information and receive the food 10. After the pickup is completed, the pickup food 10 can be delivered to the user Pu based on the map information and the delivery point DP included in the delivery destination information of the delivery information.

### (Multi-User Mode)

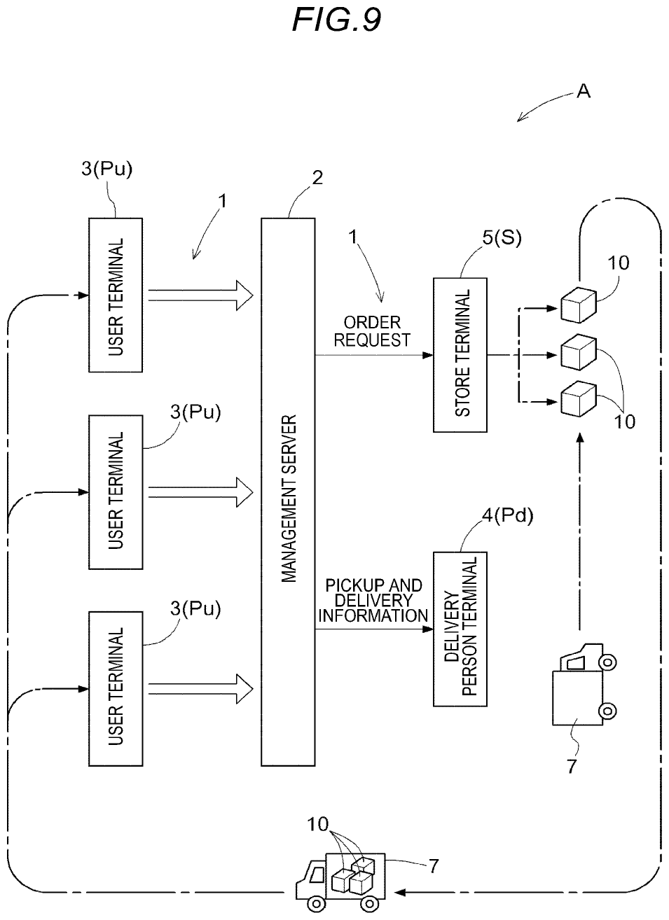

As an example of the product purchased in a multi-user mode, the food 10 cooked like a pizza, a box lunch, or a regular meal will be described. In the following description, information is transmitted as shown in a chart in FIG. 9. When the user Pu makes an order, a screen similar to that in the multi-store designation mode described above (see FIGS. 7 and 8) is displayed on the screen of the user terminal 3.

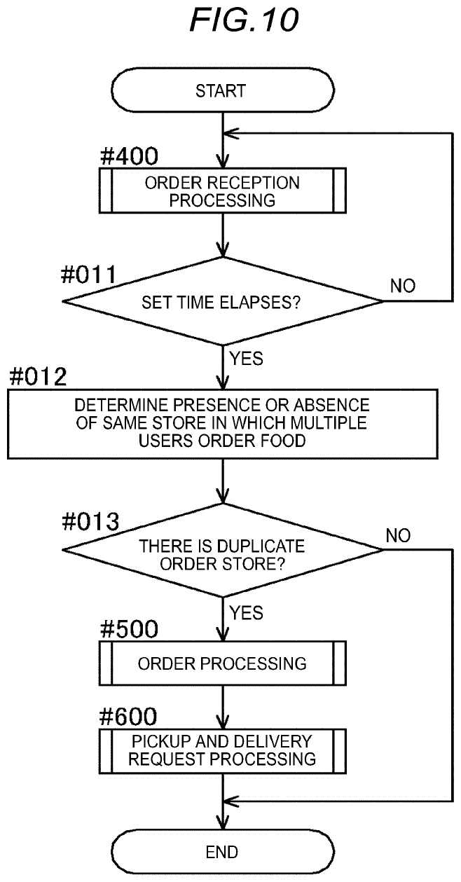

In the multi-user mode, as shown in a flowchart in FIG. 10, the management server 2 performs order reception processing (step #400, step #011) for a plurality of orders within a set time. In the order reception processing (step #400), presence or absence of the same store S (hereinafter, referred to as a duplicate order store S) in which a plurality of users Pu (users Pu who order the food 10 (product) within the set time) order the food 10 (product) is determined. When the duplicate order store S exists (Yes in steps #012 and #013), the order processing (step #500) common to the multi-user mode and pickup and delivery request processing (step #600) are performed.

In the following description, the description will be made on an assumption that the multi-user mode is determined in step #013. When the duplicate order store S does not exist (No in Step #013), the processing moves to peer-to-peer mode processing (not shown) in which the food 10 is delivered from one store S to one user Pu.

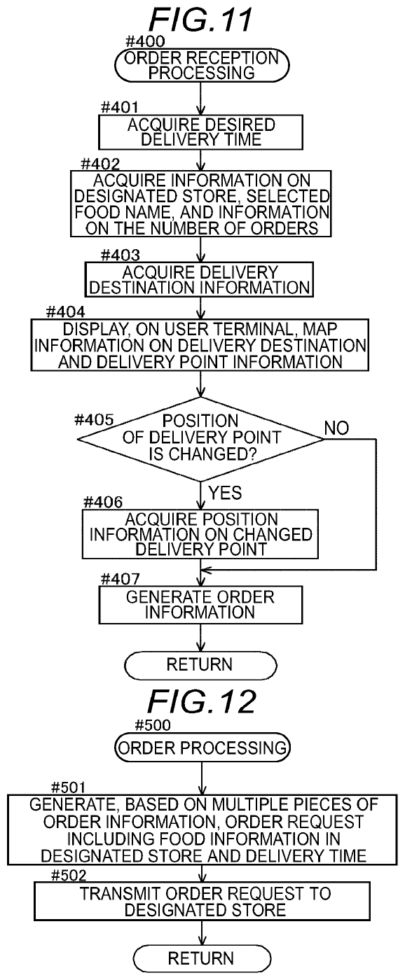

As shown in a flowchart in FIG. 11, the order reception processing (step #400) is different from the order reception processing (step #100) in the multi-store designation mode described above in that a plurality of users Pu designate one store S and the order is made in a form of selecting the food 10 in the store S. However, the processing in other steps is common to the order reception processing (step #100) in the multi-store designation mode described above.

In such a processing form, details of the processing of each step (#401 to #407) are not described, and the order information is generated in step #407.

The order processing (step #500) is performed as shown in a flowchart in FIG. 12, and is different from the order processing (step #200) in the multi-store designation mode described above in that the order request corresponding to one store S is transmitted, and processing of generating, based on a plurality of pieces of order information, order data including the total number of orders of the food 10 selected in the one store S and transmitting (transporting) the order request to the store S is performed (steps #501 and #502).

In the order processing, when a plurality of types of food 10 are included in the plurality of pieces of order information, the total number of orders obtained by adding the number of orders of the ordered food 10 in each of the plurality of types of food 10 is included in the order request.

By transmitting the order request to each store S in this manner, cooking of the food 10 can be started in each store S based on the order request, and a time at which the cooking is ended can also be set based on the delivery time information included in the order request. In the store S that receives the order request, processing of transmitting confirmation information to the management server 2 is performed.

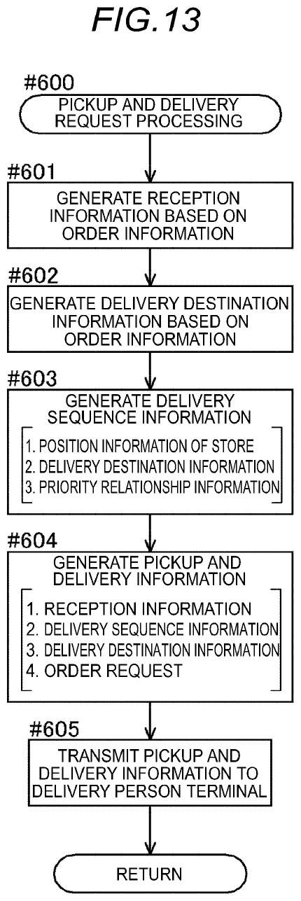

As shown in a flowchart in FIG. 13, the pickup and delivery request processing (step #600) is different from the pickup and delivery request processing (step #300) in the multi-store designation mode described above in that delivery sequence information corresponding to the pickup sequence information in step #303 is generated (step #603), whereas the processing in other steps are basically common to the processing in the multi-store designation mode described above. The delivery sequence information is generated based on the store information, the delivery destination information, and the priority relationship information set in advance. As an example of the priority relationship information, when the ordered food 10 is a food provided in a warmed state, a delivery sequence of the food is set to the first, and when the ordered food 10 is food provided at room temperature, the delivery sequence of the food is set to the last.

In such a processing form, details of the processing in steps #601 to #604 are not described, and the reception information is generated in step #601, the delivery destination information is generated in step #602, and the delivery sequence information is generated in step #603. The delivery sequence information determines a sequence of efficient and short-time delivery corresponding to the plurality of users Pu, and is generated based on the delivery destination information of the plurality of users Pu.

The pickup and delivery information generated in step #604 includes the reception information, the delivery sequence information, the delivery destination information, and the order request.

The pickup and delivery information generated in this manner is transmitted to the delivery person terminal 4 of the delivery person Pd (step #605). As described above in the multi-store designation mode, also as in the multi-user mode, the delivery information is displayed on the screen by an operation such as tapping the screen of the delivery person terminal 4 after the pickup is performed based on the pickup sequence information.

The delivery person Pd who receives the pickup and delivery information can confirm, based on the pickup sequence information displayed on the delivery person terminal 4, the position of the store S and the food 10 to be received, and after the pickup is completed, the delivery person Pd can efficiently deliver the picked-up food 10 to the plurality of users Pu by driving the vehicle 7 to travel according to the delivery sequence information based on the map information and the delivery point DP included in the delivery destination information of the delivery information.

### (Combined Pickup and Delivery Mode)

The delivery system A is configured to implement pickup and delivery in a combined pickup and delivery mode in which pickup and delivery based on a plurality of different pieces of order information are performed in parallel by traveling of one vehicle 7.

That is, the combined pickup and delivery mode is not limited to the pickup and delivery of the food 10 (product) in the multi-store designation mode and the multi-user mode described above, and is executed to efficiently perform the pickup and delivery in the modes based on a plurality of pieces of order information in the peer-to-peer mode in which the food 10 that is ordered by one user Pu in one store S is delivered.

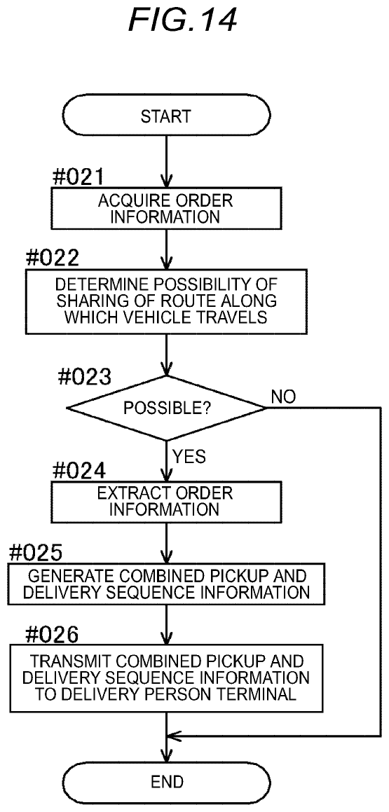

As shown in FIG. 14, in the combined pickup and delivery mode, the management server 2 acquires a plurality of pieces of order information generated within a set time (step #021), determines, based on the plurality of pieces of order information, whether a route along which the vehicle 7 travels at the time of delivery can be shared (step #022), and if yes (Yes in step #023), extracts the order information in which the route can be shared (step #024).

Next, when it is determined that the route is shared, based on the order information extracted in step #024, combined pickup and delivery sequence information is generated, and processing of delivering the combined pickup and delivery sequence information to the delivery person terminal 4 is performed (steps #025 and #026).

In particular, the combined pickup and delivery sequence information transmitted to the delivery person terminal 4 is transmitted in duplicate with the pickup and delivery information in each mode, thereby improving the efficiency of the pickup and delivery of the food 10. The processing mode may be set such that the combined pickup and delivery sequence information is transmitted instead of the pickup and delivery information in each mode.

When the combined pickup and delivery sequence information is set, it is determined whether or not the travel route of the vehicle 7 can be shared. That is, the management server 2 extracts a plurality of stores S located at positions close to one another based on the store position information of the plurality of pieces of order information, extracts a plurality of users Pu located at positions close to one another based on the delivery destination information in the plurality of pieces of order information, and determines whether the travel route of the vehicle 7 can be shared between the pickup and the delivery based on a result of the extraction.

As a result of the determination, a combination of the plurality of pieces of order information in which a sharing rate of the travel route is equal to or greater than a set value is determined, and the combined pickup and delivery sequence information is set based on the plurality of pieces of order information.

That is, the combined pickup and delivery sequence information implements a delivery form in which, in the processing of picking up the food 10 and delivering the food 10 based on one pieces of order information, at least one of pickup of the food 10 based on another piece of order information and delivery of the food 10 is interrupted.

When it is determined in step #023 that the pickup and delivery in the combined pickup and delivery mode is impossible, the delivery is performed in any one of the above-described multi-user mode, the multi-store designation mode, and the peer-to-peer mode.

By executing the pickup and delivery in the combined pickup and delivery mode, the processing of receiving the food 10 and delivering the food 10 to the user Pu based on the plurality of pieces of order information is made efficient without increasing a traveling distance of the vehicle 7 of the delivery person Pd.

### (Function and Effect of Embodiment)

As described above, the delivery system A automatically selects the multi-store designation mode and the multi-user mode to deliver the product 10. Therefore, in the multi-store designation mode, the user Pu can receive produces ordered in a plurality of stores S by one delivery. In the multi-user mode, the delivery person Pd can efficiently deliver the product without causing the vehicle to travel wastefully.

The management server 2 can receive a plurality of orders within a set time. The multi-store designation mode is determined when the order information is generated. The multi-user mode is determined by the management server 2 based on the plurality of pieces of order information. Therefore, the person who manages the management server 2 does not have to artificially set the mode.

In the multi-store designation mode, the delivery person Pd receives the products 10 at a plurality of stores S and delivers the products 10 to the user Pu by the vehicle 7. Therefore, for example, as compared with a case where one store S needs one delivery person Pd to deliver the product 10 as in the peer-to-peer mode, the vehicle 7 is not wastefully traveled and efficient delivery is implemented.

In the multi-user mode, the delivery person Pd receives the products 10 based on a plurality of pieces of order information in one store S and conveys the products 10 to a plurality of users Pu. Therefore, for example, as compared with the case where one store S needs one delivery person Pd to deliver the product 10 as in the peer-to-peer mode, the vehicle 7 is not wastefully traveled and efficient delivery is implemented.

Further, since the map and the delivery point DP are displayed as the delivery destination information on the delivery person terminal 4 and the user Pu can move the delivery point DP on the map, the delivery person Pd can accurately acquire the delivery destination information and complete the delivery of the product 10 in a short time without causing the vehicle 7 to wastefully travel.

By picking up and delivering the food 10 based on the combined pickup and delivery sequence information, not only the time required for pickup and delivery can be shortened, but also the travelling distance of the vehicle 7 can be shortened, and the efficient delivery can be implemented.

### OTHER EMBODIMENTS

This disclosure may be configured as follows in addition to the embodiment described above (parts having the same functions as those in the embodiment are denoted by the same reference numerals and signs as those in the embodiment).

(a) In the embodiment, although a cooked food is described as an example of the product 10 to be delivered, a detergent, stationery, clothing, or the like product necessary for living to be delivered can also be set as a target to be picked up and delivered as the product 10, and in the multi-store designation mode, a system may be configured to convey these products different from food along with food.

(b) The delivery system A is configured such that the delivery can be performed by selecting a delivery person Pd satisfying a predetermined condition from a plurality of delivery persons Pd who can individually perform the delivery using the vehicle 7. In the embodiment, although the number of the delivery persons Pd and the number of vehicles are not described, it is possible to select a person who is not engaged in the delivery from among the plurality of delivery persons Pd, and transmit the pickup and delivery information to the selected person, or select a delivery person Pd who is present at a position where efficient delivery can be performed. By performing such selection, more rapid pickup and delivery can be performed.

(c) The delivery system A is configured such that a route (road) along which the delivery person Pd causes the vehicle 7 to travel can be set in addition to the pickup sequence and the delivery sequence. That is, in the multi-store designation mode, by determining the route based on the pickup sequence information, a time for causing the vehicle 7 to travel to the plurality of stores S can be shortened. In the multi-user mode, by determining the route based on the delivery sequence information, a time for causing the vehicle to travel to a plurality of users Pu can be shortened.

(d) When the user logs in to the management server 2 and the store designation screen is displayed on the user terminal 3, it is conceivable to display a plurality of stores S in order of popularity, or to display the food 10 (product) in order from those that can be transported in a short time. By displaying in this manner, a popular store S is effectively recommended to the user and it is easily for the user to select a store S from which the food 10 can be received in a short time.

(e) It is conceivable to configure the system such that, on the food list screen displayed on the user terminal 3 when the store S is designated, a display sequence of the food 10 can be set from the store terminal 5, in addition to the display form as in another embodiment (d) described above. By displaying in this manner, the number of orders of the food 10 whose sales are desired to be promoted can also be increased in the store S.

(f) In the delivery system A, the delivery person Pd may perform the pickup and delivery using a bicycle or a motorcycle having an engine.

### INDUSTRIAL APPLICABILITY

This disclosure can be applied to a delivery system capable of delivering, to a user, a product that is ordered via a network.

A feature of a delivery system according to an aspect of this disclosure resides in that the delivery system includes: a management server configured to acquire and accumulate order information of an order made from a user terminal of one user within a set time via a network, the order information including at least store information on a store in which the user makes the order, product information by which an ordered product is able to be specified, delivery destination information as a delivery destination of the ordered product, and delivery time information as a time at which the product is delivered, transmit the order information acquired by the management server to a delivery person terminal of one delivery person via the network, transmit at least the product information and the delivery time information in the order information acquired by the management server to a store terminal of the store based on the store information in the order information via the network, and allow the user to order the products in a plurality of the stores in the order each time, generate the order information for the order in each time, and when it is determined that the orders of the one user are made across a plurality of the stores based on the order information accumulated within the set time, generate pickup sequence information determining a sequence in which the one delivery person is to receive the products in the plurality of the stores, and further transmit the pickup sequence information to the delivery person terminal.

According to the configuration, for example, when one user accesses the management server via the network and orders the products in a plurality of the stores, the pickup sequence information for the delivery person to receive the products in the plurality of the stores is set in the management server and transmitted to the delivery person. In this manner, since the pickup sequence information is generated, for example, a pickup sequence can be set so as to reflect a positional relationship of the plurality of the stores, time information necessary for preparing the product in each of the stores (time necessary for cooking in the case of a box lunch), time based on road information on a road on which the delivery person moves in the vehicle, or the like, and efficient pickup is possible.

Therefore, a system capable of reducing a wasteful delivery of the product even when the user orders the products in a plurality of the stores is configured.

A feature of a management server according to an aspect of this disclosure resides in that the delivery system includes: a management server configured to acquire and accumulate order information of an order made from a user terminal of each of one or a plurality of users within a set time via a network, the order information including at least store information on a store in which the user makes the order, product information by which an ordered product is able to be specified, delivery destination information as a delivery destination of the ordered product, and delivery time information as a time at which the product is delivered, transmit the order information acquired by the management server to a delivery person terminal of one delivery person via the network, transmit at least the product information and the delivery time information in the order information acquired by the management server to a store terminal of the store based on the store information in the order information via the network, and allow each of the users to order products in a plurality of the stores in the order each time, generate the order information for the order in each time, and when it is determined, based on the order information accumulated within the set time, that a plurality of the users make orders in the same store, sets delivery sequence information determining a sequence in which the one delivery person is to deliver the products to the plurality of the users who make orders in the same store, and further transmit the delivery sequence information to the delivery person terminal.

According to the configuration, for example, when a plurality of the users access the management server via the network and order the products in the same store within the set time, the delivery sequence information determining the sequence in which the delivery person is to deliver the products to the plurality of the users after receiving the products in the store is set in the management server and transmitted to the delivery person terminal. By setting the delivery sequence, a traveling time and a travelling distance of the vehicle can be shortened.

Therefore, a system capable of reducing a wasteful delivery of the products even when the plurality of the users order the products in the same store is configured.

As another configuration, the management server may set, as the pickup sequence information, a sequence in which the delivery person is to receive the products sequentially from the plurality of the stores using a vehicle, based on store position information of the plurality of the stores in which the user orders the products and priority relationship information set in advance.

Accordingly, by causing the vehicle to travel so as to receive the products from a plurality of the stores according to the pickup sequence information, the reception reflecting the priority relationship information can be performed.

As another configuration, the management server may set, as the delivery sequence information, a sequence in which the delivery person is to deliver the products sequentially to the plurality of the users using a vehicle, based on a plurality of pieces of the delivery destination information and priority relationship information set in advance.

Accordingly, by causing the vehicle to travel so as to deliver the products to a plurality of the users according to the delivery sequence information, the deliver reflecting the priority relationship information can be performed.

As another configuration, the delivery person may perform pickup and delivery of the product using a vehicle, and the management server may set combined pickup and delivery sequence information that enables the pickup and the delivery based on a plurality of pieces of the order information, and transmit the combined pickup and delivery sequence information and the plurality of pieces of order information to the delivery person terminal.

Accordingly, for example, it is possible to perform the pickup in which the vehicle is moved to the store based on one piece of order information to receive the product, then perform the pickup in which the vehicle is moved to another store based on another piece of order information to receive the product, and then perform the delivery in which the products are delivered to different users based on pieces of order information. In this way, a travelling distance of the vehicle can be shortened by mixing the pickup and the delivery based on the plurality of pieces of order information.

As another configuration, when receiving the order from the user, the management server may enable designation of the delivery time based on a desire of the user, and transmit the acquired delivery time information to the delivery person terminal.

Accordingly, the delivery time information set based on the desire of the user is transmitted to the delivery person terminal, and the delivery person can easily deliver the product before the time designated by the user is reached.

As another configuration, when the management server is connected from the user terminal, and acquires the delivery destination information, the management server may cause the user terminal to display map information and a delivery point corresponding to the delivery destination information in a manner of being overlapped on the map information, enable a position of the delivery point to be changed by an operation on the user terminal, and when the position of the delivery point is changed, transmit position information of the delivery point after the change to the delivery person terminal.

Accordingly, when the management server is connected from the user terminal and acquires the delivery destination information, the map information is displayed on the user terminal, and the delivery point corresponding to the delivery destination information is displayed in a manner of being overlapped on the map information. When the delivery destination information is a residential display of the user and an area for the residential display is wide, it is considered that the delivery point may not be accurate. When the delivery point is not accurate as described above, the user changes the delivery point on the map information, so that the changed delivery point position information is transmitted to the delivery person terminal, and the delivery person can deliver the product to the accurate position.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A delivery system comprising:
a management server configured to
acquire and accumulate order information of an order made from a user terminal of one user within a set time via a network, the order information including at least store information on a store in which the user makes the order, product information by which an ordered product is able to be specified, delivery destination information as a delivery destination of the ordered product, and delivery time information as a time at which the product is delivered,
transmit the order information acquired by the management server to a delivery person terminal of one delivery person via the network,
transmit at least the product information and the delivery time information in the order information acquired by the management server to a store terminal of the store based on the store information in the order information via the network, and
allow the user to order the products in a plurality of the stores in the order each time, generate the order information for the order in each time, and when it is determined that the orders of the one user are made across a plurality of the stores based on the order information accumulated within the set time, generate pickup sequence information determining a sequence in which the one delivery person is to receive the products in the plurality of the stores, and further transmit the pickup sequence information to the delivery person terminal.

2. The delivery system according to claim 1, wherein
the management server sets, as the pickup sequence information, a sequence in which the delivery person is to receive the products sequentially from the plurality of the stores using a vehicle, based on store position information of the plurality of the stores in which the user orders the products and priority relationship information set in advance.

3. The delivery system according to claim 1, wherein
the delivery person performs pickup and delivery of the product using a vehicle, and
the management server sets combined pickup and delivery sequence information that enables the pickup and the delivery based on a plurality of pieces of the order information, and transmits the combined pickup and delivery sequence information and the plurality of pieces of order information to the delivery person terminal.

4. The delivery system according to claim 1, wherein,
when receiving the order from the user, the management server enables designation of the delivery time based on a desire of the user, and transmits the acquired delivery time information to the delivery person terminal.

5. The delivery system according to claim 1, wherein
when the management server is connected from the user terminal, and acquires the delivery destination information, the management server causes the user terminal to display map information and a delivery point corresponding to the delivery destination information in a manner of being overlapped on the map information, enables a position of the delivery point to be changed by an operation on the user terminal, and when the position of the delivery point is changed, transmits position information of the delivery point after the change to the delivery person terminal.

6. A delivery method using a management server comprising:
acquiring and accumulating, by the management server, order information of an order made from a user terminal of each of one or a plurality of users within a set time via a network, the order information including at least store information on a store in which the user makes the order, product information by which an ordered product is able to be specified, delivery destination information as a delivery destination of the ordered product, and delivery time information as a time at which the product is delivered;
transmitting the order information acquired by the management server to a delivery person terminal of one delivery person via the network;
transmitting at least the product information and the delivery time information in the order information acquired by the management server to a store terminal of the store based on the store information in the order information via the network; and
allowing each of the users to order products in a plurality of the stores in the order each time, generating the order information for the order in each time, based on the order information accumulated within the set time, when it is determined that an order of one of the users are made across a plurality of the stores, generating pickup sequence information determining a sequence in which the one delivery person is to receive the products in the plurality of the stores, and when it is determined that a plurality of the users make orders in the same store, setting delivery sequence information determining a sequence in which the one delivery person is to deliver the products to the plurality of the users who make orders in the same store, and further transmitting the pickup sequence information and the delivery sequence information to the delivery person terminal.

7. The delivery method according to claim 6, wherein
the management server sets, as the pickup sequence information, a sequence in which the delivery person is to receive the products sequentially from the plurality of the stores using a vehicle, based on store position information of the plurality of the stores in which the user orders the products and priority relationship information set in advance.

8. The delivery method according to claim 6, wherein
the management server sets, as the delivery sequence information, a sequence in which the delivery person is to deliver the products sequentially to the plurality of the users using a vehicle, based on a plurality of pieces of the delivery destination information and priority relationship information set in advance.

9. The delivery method according to claim 6, wherein
the delivery person performs pickup and delivery of the product using a vehicle, and
the management server sets combined pickup and delivery sequence information that enables the pickup and the delivery based on a plurality of pieces of the order information, and transmits the combined pickup and delivery sequence information and the plurality of pieces of order information to the delivery person terminal.

10. The delivery method according to claim 6, wherein
when receiving the order from the user, the management server enables designation of the delivery time based on a desire of the user, and transmits the acquired delivery time information to the delivery person terminal.

11. The delivery method according to claim 6, wherein
when the management server is connected from the user terminal and acquires the delivery destination information, the management server causes the user terminal to display map information and a delivery point corresponding to the delivery destination information in a manner of being overlapped on the map information, enables a position of the delivery point to be changed by an operation on the user terminal, and when the position of the delivery point is changed, transmits position information of the delivery point after the change to the delivery person terminal.

12. The delivery method according to claim 11, wherein
the delivery point after the change is included in an area of which the one delivery person is in charge.

13. The delivery method according to claim 6, wherein
the plurality of the stores are included in an area of which the one delivery person is in charge.

14. The delivery method according to claim 6, wherein
the plurality of the users are included in an area of which the one delivery person is in charge.

15. A delivery system comprising:
a management server configured to
acquire and accumulate order information of an order made from a user terminal of each of one or a plurality of users within a set time via a network, the order information including at least store information on a store in which the user makes the order, product information by which an ordered product is able to be specified, delivery destination information as a delivery destination of the ordered product, and delivery time information as a time at which the product is delivered,
transmit the order information acquired by the management server to a delivery person terminal of one delivery person via the network,
transmit at least the product information and the delivery time information in the order information acquired by the management server to a store terminal of the store based on the store information in the order information via the network, and
allow each of the users to order products in a plurality of the stores in the order each time, generate the order information for the order in each time, and when it is determined, based on the order information accumulated within the set time, that a plurality of the users make orders in the same store, set delivery sequence information determining a sequence in which the one delivery person is to deliver the products to the plurality of the users who make orders in the same store, and further transmit the delivery sequence information to the delivery person terminal.

16. The delivery system according to claim 15, wherein
the management server sets, as the delivery sequence information, a sequence in which the delivery person is to deliver the products sequentially to the plurality of the users using a vehicle, based on a plurality of pieces of the delivery destination information and priority relationship information set in advance.

17. The delivery system according to claim 15, wherein
the delivery person performs pickup and delivery of the product using a vehicle, and
the management server sets combined pickup and delivery sequence information that enables the pickup and the delivery based on a plurality of pieces of the order information, and transmits the combined pickup and delivery sequence information and the plurality of pieces of order information to the delivery person terminal.

18. The delivery system according to claim 15, wherein
when receiving the order from the user, the management server enables designation of the delivery time based on a desire of the user, and transmits the acquired delivery time information to the delivery person terminal.

19. The delivery system according to claim 15, wherein
when the management server is connected from the user terminal and acquires the delivery destination information, the management server causes the user terminal to display map information and a delivery point corresponding to the delivery destination information in a manner of being overlapped on the map information, enables a position of the delivery point to be changed by an operation on the user terminal, and when the position of the delivery point is changed, transmits position information of the delivery point after the change to the delivery person terminal.
